(19) United States
(12) Patent Application Publication
(10) Pub. No.: US 2008/0278670 A1
(43) Pub. Date: Nov. 13, 2008

(54) Liquid crystal display device and method for manufacturing the same

(75) Inventors: Makoto Abe, Sendai (JP); Tsutomu Tanaka, Sendai (JP); Makoto Tsumura, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Future Vision Inc.

(21) Appl. No.: 12/149,420

(22) Filed: May 1, 2008

(30) Foreign Application Priority Data
May 7, 2007 (JP) 2007-122441
Jan. 11, 2008 (JP) 2008-003918

(51) Int. Cl. G02F 1/1343; H01J 9/00

(52) U.S. Cl. 349/144; 445/24

(57) ABSTRACT

The present invention provides a liquid crystal display device, by which it is possible to improve color reproducibility and contrast by adequately setting a value of Δn·d of each color without changing thickness of liquid crystal layer. A partition wall PT made of resin is prepared between pixels, which comprises color filter columns of CF-R, CF-G and CF-B. Within each of the pixels partitioned by the partition wall, liquid crystals LC(R), LC(G), and LC(B) having different values of Δn are filled In the pixels partitioned by the partition wall. The partition wall PT also fulfills the function as a spacer to maintain cell gap at a predetermined value.

### BACKGROUND OF THE INVENTION

1. Field of the Invention

The present invention relates to a liquid crystal display device. In particular, the invention relates to a liquid crystal display device for improving contrast by controlling the changes of chromaticity due to the viewing angle. The invention also relates to a method for manufacturing the liquid crystal display device as described above.

2. Description of the Prior Art

In a liquid crystal display device, contrast and viewing angle are changed by the product (Δn·d) of refractive index anisotropy (Δn) and layer thickness (cell gap) (d) of liquid crystal. When an image is displayed in a normally black mode, the contrast in front direction is decreased. In the liquid crystal display device of full-color to give multi-color display by using a plurality of color filters represented by three colors of red, green and blue, frequencies of display light, which pass through the color filter via the liquid crystal, differ according to the colors. Thus, when the viewing angle is changed, the value of Δn·d is varied. As a result, chromaticity is changed.

FIG. 12 represents drawings to explain an example of arrangement of one pixel in the liquid crystal display device. FIG. 12 (a) is a plan view, and FIG. 12 (b) is a cross-sectional view along the line A-A′ in FIG. 12 (a). This liquid crystal display device is the so-called TN type, and it comprises a thin-film transistor (TFT) on inner surface of one insulating substrate (hereinafter referred as “glass substrate”) SUB1 and a pixel electrode PX driven by this TFT. Each of the pixel electrodes PX makes up sub-pixel for color display. To facilitate the explanation, it is simply referred below as “pixel” except the case where it is necessary to explain more precisely. In FIG. 12, the other glass substrate with a counter electrode is not shown. The liquid crystal display device comprises a driving circuit, a display control circuit substrate, a backlight and other component members mounted on a liquid crystal display panel. The important point of the invention lies in the arrangement of the liquid crystal display panel. In the following, the liquid crystal display panel is referred as the liquid crystal display device.

The glass substrate SUB1 is also called a TFT substrate or an active matrix substrate, and it comprises a gate electrode GT constituted by a gate line GL, a gate insulator GI, a semiconductor layer AS preferably made of silicon, an n+ semiconductor layer (ohmic contact layer), a source electrode (or a drain electrode) and a drain electrode (or a source electrode) SD, a passivation layer PAS, and a pixel electrode PX. The pixel electrode PX is electrically connected to a source electrode (or a drain electrode) via a through-hole TH formed on the passivation layer PAS. The drain electrode SD (or the source electrode) is extended from a data line (drain line) DL and is formed on the n+ semiconductor layer. In this example, a capacity line CE is arranged in the lower layer of the pixel electrode across the pixel area.

FIG. 13 is a schematical drawing to explain optical transmittance of each color in the liquid crystal display device shown in FIG. 12. In FIG. 13, the same component as in FIG. 12 is referred by the same symbol. SUB2 is the other of glass substrates as described above. Because color filters CF-R (red), CF-G (green) and CF-B (blue) are provided on it, this substrate is called a color filter substrate (CF substrate). Each of the color filters CF-R, CF-G and CF-B constitutes a sub-pixel for color display, and one group of the three sub-pixels makes up one pixel (unit pixel) for color display. Each of the color filters CF-R, CF-G, and CF-B is partitioned by a black matrix BM, with the counter electrode (common electrode) is formed on it. And an orientation film (not shown) is deposited on the innermost surface. This orientation film has liquid crystal orientation control ability such as rubbing processing. A similar orientation film is also prepared on the innermost surface of the TFT substrate SUB1, and the same liquid crystal orientation control ability is provided. On outer surface of the TFT substrate SUB1 and the CF substrate SUB2, a lower polarizing plate POLL and an upper polarizing plate POL2 are disposed.

Each of the arrows directed in upward direction in FIG. 13 represents a light projected as an observation light, i.e. a white light, which is projected from a backlight (not shown) and passes through the TFT substrate SUB1 and the CF substrate SUB2. In the arrangement as described above, the liquid crystal layer LC is common to all sub-pixels, and layer thickness of the liquid crystal layer of each color, i.e. cell gap, is the same. Transmittance (optical transmittance) T of the sub-pixel can be expressed by the following equation:

T=sin²{πΔn·d/λr}

where the symbol λr represents central wavelength of the transmitting color of the sub-pixel, the symbol Δn is refractive index anisotropy of the liquid crystal, and the symbol d is layer thickness of the liquid crystal layer. The optical transmittance varies according to each pixel.

FIG. 14 is a schematical drawing to show an example of optical transmittance for each pixel unit. The color filters CF-R, CF-G and CF-B provided to the pixels of different colors have the values of optical transmittance different from each other. In the case shown in FIG. 14 where the value of Δn of the liquid crystal is 0.0968 and layer thickness of the liquid crystal layer LC is 2.85 μm, if it is supposed to be 100% in the green pixel of the color filter CF-G, it is 94.5% in the red pixel, and 87.9% in the blue pixel. Because the values of the transmittance of three colors differ from each other, chromaticity is changed. In the display of a normally open mode, the display should be in white color, while it is changed to yellow color, and the display, which should be in black color in the display of a normally closed mode, it has a different color.

In order to control and suppress such change of chromaticity, the Patent Document 1 as given below discloses a technique, according to which the layer thickness of transparent insulating layer (top coating) to cover the pixel electrode or the color filter is varied for each of the colors or the layer thickness of the color filter is varied for each of the colors. Also, the Patent Document 2 discloses a multi-gap system, by which thickness of the glass substrate to form the pixel electrode is changed for each pixel.

[Patent Document 1] JP-A-7-175050

[Patent Document 2] JP-A-7-28071

### SUMMARY OF THE INVENTION

According to the means disclosed in the Patent Document 1, by which the thickness of the top coating is varied for each color, or layer thickness of the color filter is varied for each color, it is difficult to accurately set each layer thickness, and variations are very likely to occur on the graded step between the adjacent pixels. Further, it is difficult to set an adequate value of Δn·d for each pixel. According to the means to change the thickness of the glass substrate for each pixel as disclosed in the Patent Document 2, the number of processes to fabricate the glass substrate is increased, and it is also difficult to precisely prepare various types of thin films to be coated between the adjacent pixels or the graded steps between insulator films such as pixel electrode, top coating, etc.

It is a first object of the present invention to provide a liquid crystal display device, by which it is possible to improve color reproducibility and contrast by adequately setting the value of Δn·d of each color without changing the layer thickness of the liquid crystal layer. Also, it is a second object of the invention to provide a method for manufacturing the liquid crystal display device as described above.

To attain the first object of the invention as described above, the present invention provides a liquid crystal display device, which comprises a first substrate where a multiple of pixels with different display colors are arranged, a second substrate disposed at a position opposite to said substrate, and a liquid crystal layer sandwiched between said first substrate and said second substrate, and refractive index anisotropy Δn (λ) of said liquid crystal layer at an arbitrary wavelength λ varies according to display color of said pixel.

Also, the present invention provides the liquid crystal display device described above, wherein a first substrate where a multiple of pixels with different display colors are arranged, a second substrate disposed at a position opposite to said substrate, and a liquid crystal layer sandwiched between said first substrate and said second substrate, and a display unit is constituted by a plurality of pixels with display colors different from each other, and refractive index anisotropy Δn (λ) of said liquid crystal layer at an arbitrary wavelength λ varies according to display color of said pixel.

Further, the present invention provides the liquid crystal display device described above, wherein, to a first liquid crystal layer applied to a first pixel having one display color with central optical wavelength λ₁ and a second liquid crystal layer applied to a second pixel having the other display color, the following relation can be satisfied:

sin²(λ·d·Δn₁(λ₁)/λ₁)>sin²(π·d·nΔn₂(λ₁)/λ₁)

where the symbol Δn₁ (λ₁) represents refractive index anisotropy at wavelength λ₁ of the first liquid crystal layer, the symbol Δn₂ (λ₁) represents refractive index anisotropy at wavelength λ₁ of the second liquid crystal layer, and the symbol d represents thickness of the liquid crystal layer.

Also, the present invention provides the liquid crystal display device as described above, wherein there are provided partition walls to partition between pixels having different display colors. Further, the present invention provides the liquid crystal display device described above, wherein a first partition wall for dividing pixels having different display colors is provided, and there is provided a second partition wall to divide one or more pixels having the same display color.

Also, to attain the second object of the invention, the present invention provides a method for manufacturing a liquid crystal display device, which comprises the steps of:

preparing a multiple of pixels, which comprise a plurality of pixels having colors different from each other, on a first substrate;

coating a liquid crystal having different refractive index anisotropy for each different display color on each of the corresponding pixel on said first substrate; and

placing a second substrate at a position opposite to said first substrate, and sealing said liquid crystal. In the present invention, it is preferable to use ink jet method for coating the liquid crystal as described above.

The layer thickness of the liquid crystal layer is set to a constant value, and the value of Δn to constitute each pixel is set to different values. By setting the value of Δn of each pixel to such a value that the value of sin² (Δn·d/λ) will be 1 with respect to the central optical wavelength λ of pixel, it is possible to provide a liquid crystal display device, by which color reproducibility and contrast can be improved without changing the layer thickness of the liquid crystal layer. Also, it is so designed that the liquid crystal layer comprises one liquid crystal layer where a pixel having display color of the central optical wavelength λ₁ is applied, and the other liquid crystal layer as applied to a pixel having the other display color, and high effects for practical applications can be accomplished by setting the value of Δn·d to satisfy the following relation:

sin²(π·d·Δn₁(λ₁)/λ₁)>sin²(π·d·Δn₂(λ₁)/λ₁)

where the symbol Δn₁ (λ₁) represents refractive index anisotropy at wavelength λ₁ of the first (the one) liquid crystal layer, the symbol Δn₂ (λ₁) represents refractive index anisotropy at wavelength λ₁ of the second (the other) of liquid crystal layer, and the symbol d represents thickness of the liquid crystal layer.

### BRIEF DESCRIPTION OF THE DRAWINGS

FIG. 1 is a schematical cross-sectional view to explain Embodiment 1 of a liquid crystal display device according to the present invention;

FIG. 2 is a schematical plan view to explain the Embodiment 1 of a liquid crystal display device according to the present invention;

FIG. 3 is a plan view showing pixels in matrix arrangement of 4×2 by enlarging a portion A in FIG. 2;

FIG. 4 is a schematical cross-sectional view of a TFT substrate to explain a method for manufacturing the Embodiment 1 of the liquid crystal display device according to the invention;

FIG. 5 is a schematical drawing to explain an example of a method for coating liquid crystal for manufacturing the Embodiment 1 of the liquid crystal display device according to the present invention;

FIG. 6 is a schematical cross-sectional view to explain Embodiment 2 of the liquid crystal display device of the invention;

FIG. 7 is a schematical drawing to explain an example of a method for coating a liquid crystal similar to the one shown in FIG. 5 to explain the manufacturing method of FIG. 2 of the liquid crystal display device of the invention;

FIG. 8 is a plan view of an essential portion to explain Embodiment 3 of the liquid crystal display device of the invention;

FIG. 9 is a schematical plan view similar to FIG. 2 to explain Embodiment 4 of the liquid crystal display device of the invention;

FIG. 10 is a plan view similar to FIG. 8 showing pixels in matrix arrangement of 16×4 by enlarging a portion B of FIG. 2;

FIG. 11 is a schematical plan view similar to FIG. 9 to explain Embodiment 5 of the liquid crystal display device of the invention;

FIG. 12 represents drawings to explain arrangement example of one pixel of the liquid crystal display device;

FIG. 13 is a schematical drawing to explain light transmittance of each color in the liquid crystal display device shown in FIG. 12; and

FIG. 14 is a schematical drawing to show an example of light transmittance for each pixel unit.

### DESCRIPTION OF THE PREFERRED EMBODIMENTS

Detailed description will be given below on the best aspect of the invention referring to the attached drawings.

### Embodiment 1

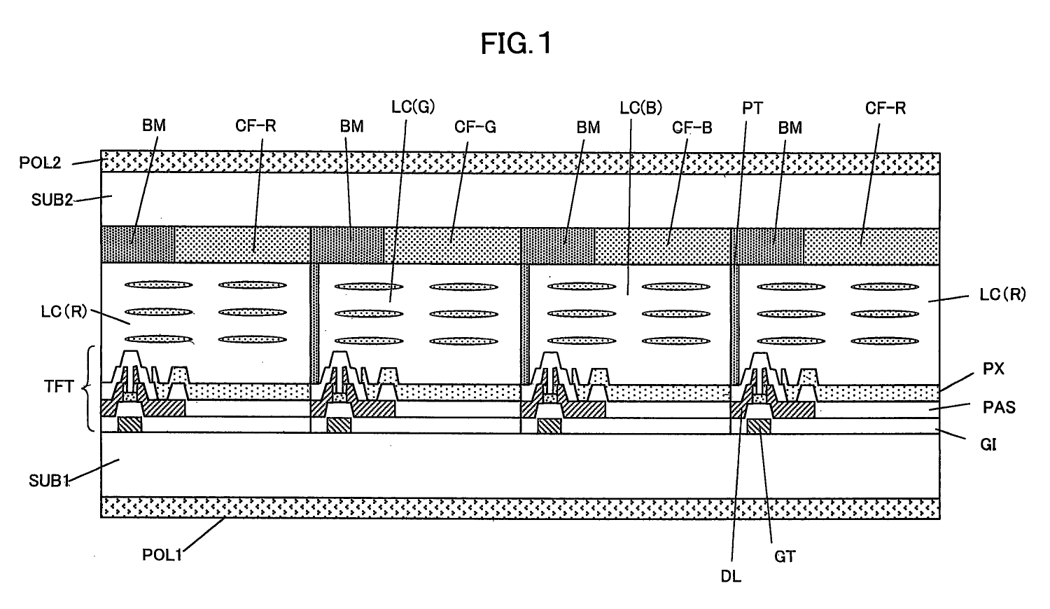

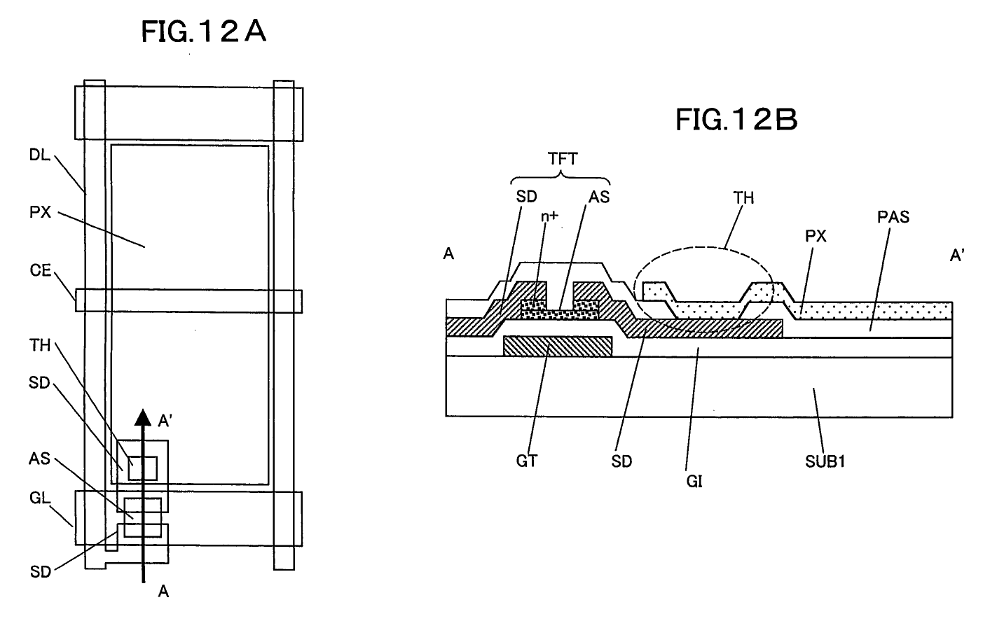

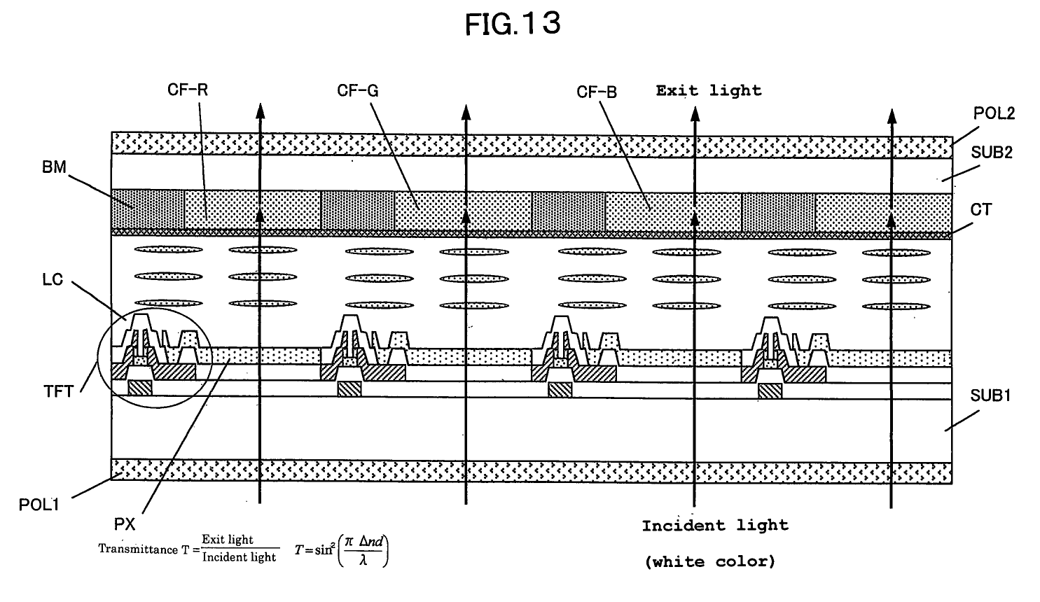

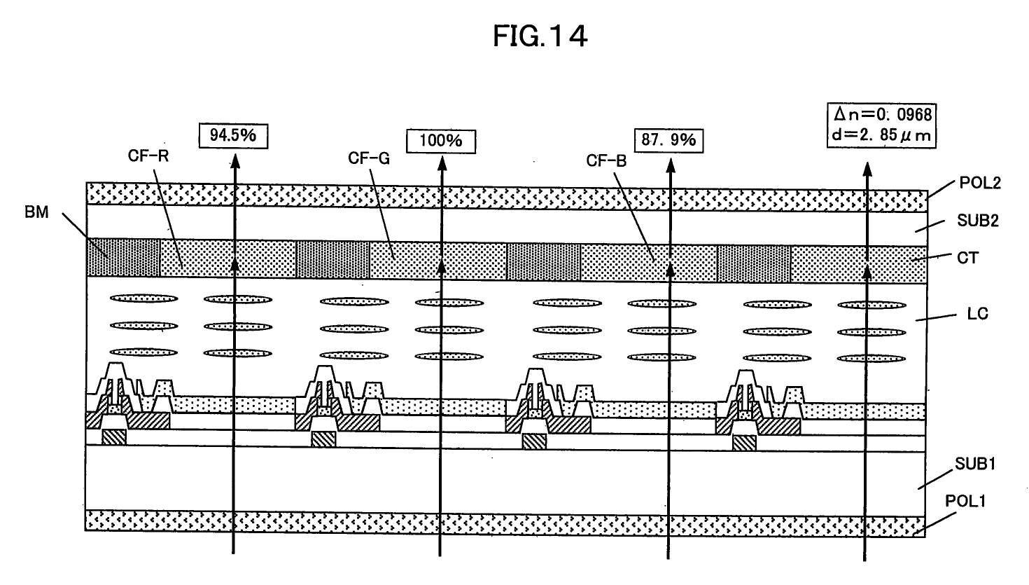

FIG. 1 is a schematical cross-sectional view to explain Embodiment 1 of a liquid crystal display device according to the present invention. A TFT is provided on inner surface of a glass substrate SUB1, which is a TFT substrate, and there are provided a protective film, a pixel electrode and an orientation film. On the other hand, color filters CF-R (red), CF-G (green), CF-B (blue), a counter electrode, an orientation film, etc. are disposed as these are partitioned by black matrix BM on inner surface of a glass substrate SUB2, which is a color filter substrate. A partition wall PT is provided between the pixels. The orientation film, the counter electrode, etc. are not shown in FIG. 1. Except the partition wall PT, the same symbol as given in FIG. 12 to FIG. 14 represents the same component.

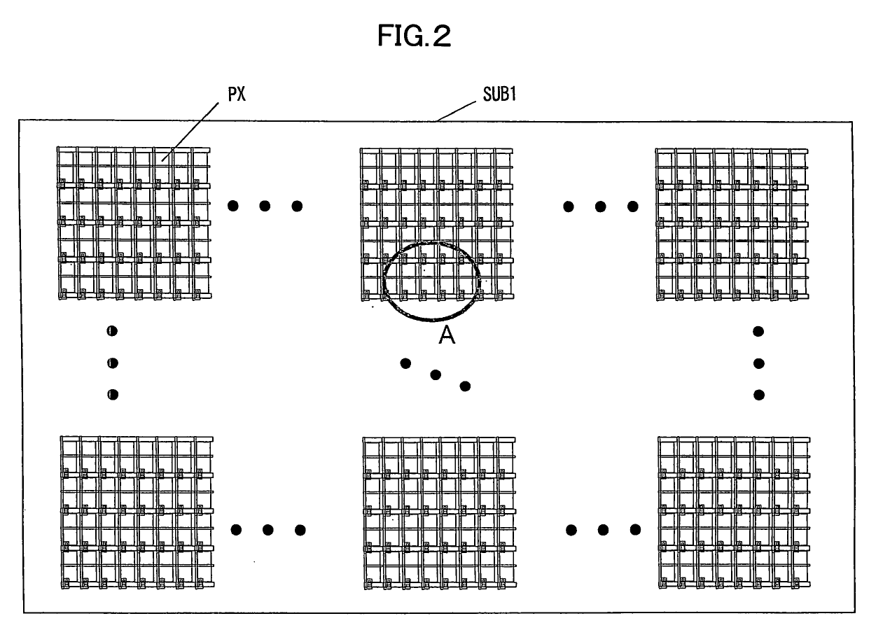

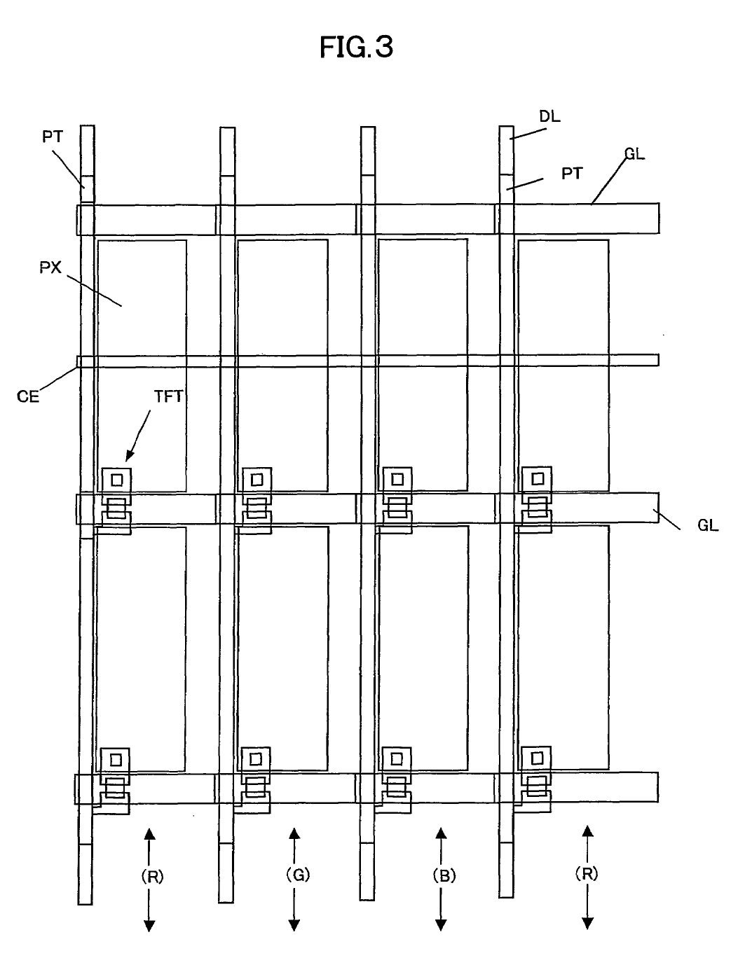

FIG. 2 is a schematical plan view to explain the Embodiment 1 of the liquid crystal display device of the present invention. Pixels PX in matrix arrangement of 8×4 are shown only at four corners and on upper and lower portions at the center of the glass substrate SUB1. FIG. 3 is a plan view to show pixels in matrix arrangement of 4×2 shown by enlarging a portion A of FIG. 2. One pixel (here, one of sub-pixels to make up one pixel (unit pixel) in color display) is formed on an area surrounded by a gate line GL and a data line DL. In the Embodiment 1, pixels of red, green and blue respectively are arranged in up-to-bottom direction in the figure as shown by arrows. In other words, rows of color filters of the same colors (R), (G) and (B) are arranged in parallel to each other in the directions shown by the arrows.

In the Embodiment 1, partition walls PT made of resin are disposed between the color filters (R), (G) and (B). Each partition wall PT is arranged along the data line DL and disposed on it. The inner space of each pixel divided by the partition wall PT is filled with liquid crystals, i.e. LC(R), LC(G) and LC(B) respectively, each of which has a value of Δn for each color inside the pixel. The partition wall PT also fulfills the function as a spacer to maintain a cell gap to a predetermined value.

The value of Δn for each of the colors is 0.1199 in R pixel, 0.0968 in G pixel and 0.0824 in B pixel. Film thickness d of the liquid crystal layer is 2.85 μm. Therefore, the value of Δn·d is 0.341 μm in R pixel, 0.275 μm in G pixel, and 0.234 μm in B pixel. Ideal value of sin² (πΔn·d/λ) is 1 to central optical wavelength of the pixel of each color. Here, it is assumed that there are provided one liquid crystal layer applied to the pixel having a display color of central optical wavelength λ₁ and the other liquid crystal layer applied to the pixel having the other display color, that refractive index anisotropy at the wavelength λ₁ of the one liquid crystal layer is Δn₁ (λ₁), and that refractive index anisotropy at the wavelength λ₁ of the other liquid crystal layer is Δn₂ (λ₁), and that the thickness of the liquid crystal layer is d. Then, there is practically no problem if the value of Δn·d is determined to satisfy the following relation:

sin²(π·d·Δn₁(λ₁)/λ₁)>sin²(λ·d·Δn₂(λ₁)/λ₁)

According to the present embodiment, a liquid crystal display device is provided, which can improve color reproducibility and contrast.

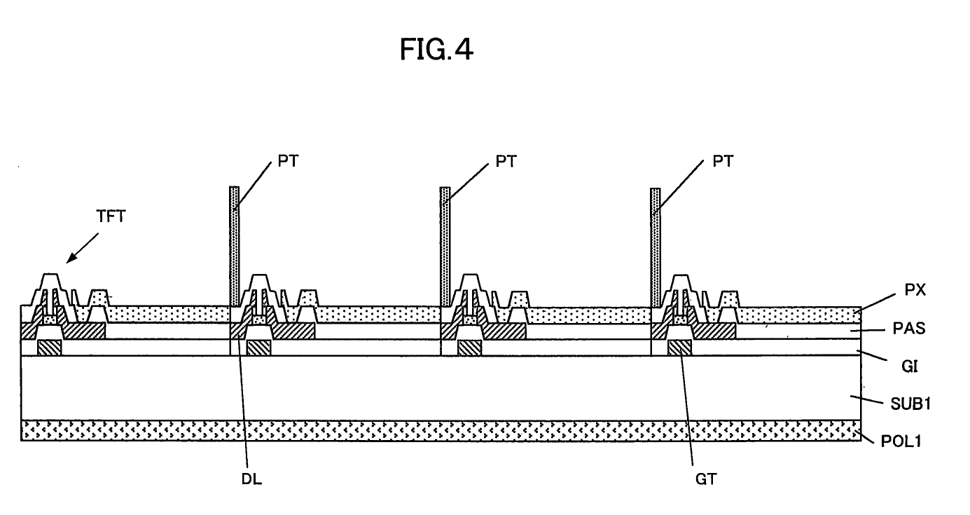

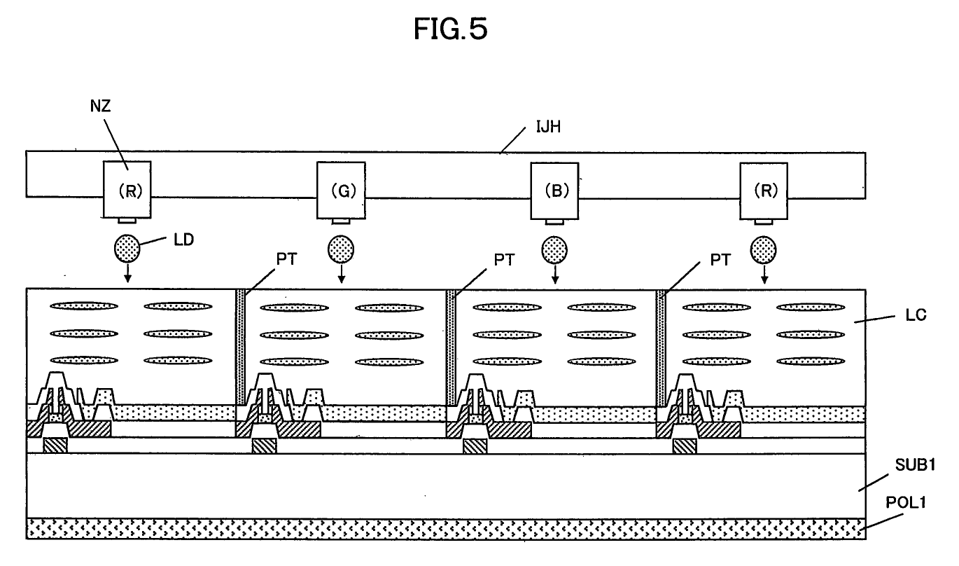

FIG. 4 is a schematical cross-sectional view of a TFT substrate to explain a method for manufacturing the liquid crystal display device of the present invention as explained in the Embodiment 1. FIG. 5 is a drawing to explain an example of a method for coating a liquid crystal in the method for manufacturing the liquid crystal display device of the Embodiment 1 of the present invention. In FIG. 4 and FIG. 5, the same symbol as in FIG. 1 refers to the same component. First, as shown in FIG. 4, a TFT is prepared on inner surface of a glass substrate SUB1, which is a TFT substrate, and an orientation film is coated to give liquid crystal orientation control ability. (The orientation film is not shown in FIG. 4 and FIG. 5.) A partition wall PT made of resin is arranged along a data line DL of the TFT substrate. The partition wall PT is preferably prepared by screen printing method, while the other means such as photolithographic process may be used. In FIG. 4 and FIG. 5, the thickness of the partition wall is shown as extremely thinner than the height. This is to emphasize the function as the wall. In fact, the height is to match the cell gap, and the partition wall can be prepared by the means such as screen printing. Also, the partition wall PT may be disposed at a position closer to the CF substrate SUB2.

After the partition wall PT as shown in FIG. 4 has been prepared, a liquid crystal is coated on each of individual pixel portions partitioned by the partition wall. To coat the liquid crystal, ink jet method is used in this embodiment as shown in FIG. 5. Specifically, an ink jet coating head IJH where a plurality of ink jet nozzles (IJ nozzles) NZs corresponding to a plurality of colors are arranged. In the ink jet coating head IJH as shown in FIG. 5, a plurality of IJ nozzles NZs of red (R), green (G), blue (B), red (R), . . . respectively are used (only four nozzles are shown in FIG. 5). The ink jet coating head IJH is relatively moved with respect to the TFT substrate where the partition wall PT is prepared, and liquid drops LDs are dropped to the corresponding pixel portion. The value of Δ n of the liquid crystal of each color is as described above.

The liquid crystal drops LDs are dropped to each pixel portion, and the liquid crystal is filled into the pixel portion. Now, description will be given on the quantity of the liquid crystal to be dropped. It is supposed here that the size of the pixel to be prepared on the TFT substrate is 150 μm×450 μm and cell gap (thickness of liquid crystal layer: d) is 2.85 μm, and that the number of pixels in horizontal direction is 768. In this case, if it is supposed that the size of the liquid crystal drop is 147.7 μl (pico-liter), the number of the drops is 1000 drops per column of pixels in horizontal direction, and the total dropped quantity is 147,744 μl.

The number of the liquid crystal drops LDs and the size of each drop exert influence on production yield. From the viewpoint of the production yield, it would be better that the liquid crystal drops are big. However, when the size of the liquid crystal drop is big, the discharge quantity from the IJ nozzle may be lower or it may be difficult to precisely control the discharge quantity. As a result, the yield is decreased. If the size of the liquid crystal drop is reduced and the number of drops is increased, the product with high quality can be produced.

In the Embodiment 1 as described above, it is possible to provide a liquid crystal display device, which can display images with high quality and can improve the contrast by controlling the changes of chromaticity due to the viewing angle.

### Embodiment 2

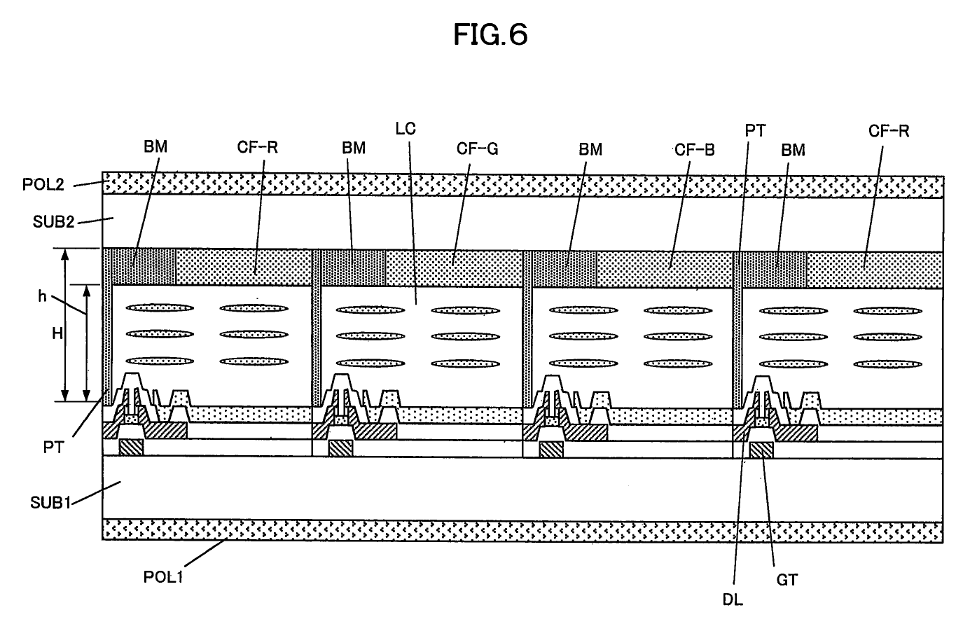

FIG. 6 is a schematical cross-sectional view to explain Embodiment 2 of the liquid crystal display device of the present invention. The same component as in FIG. 1 is referred by the same symbol. In FIG. 6 also, the orientation film, the counter electrode, etc. are not shown. In the Embodiment 1, the partition wall PT is abutted to a black matrix BM of the CF substrate, and the adjacent pixels are partitioned. In the present Embodiment 2, the black matrix where the partition wall PT is disposed is partially removed, and the partition wall PT is directly abutted to the CF substrate. That is, if it is supposed that the cell gap is h, the height H of the partition wall PT is: H>h.

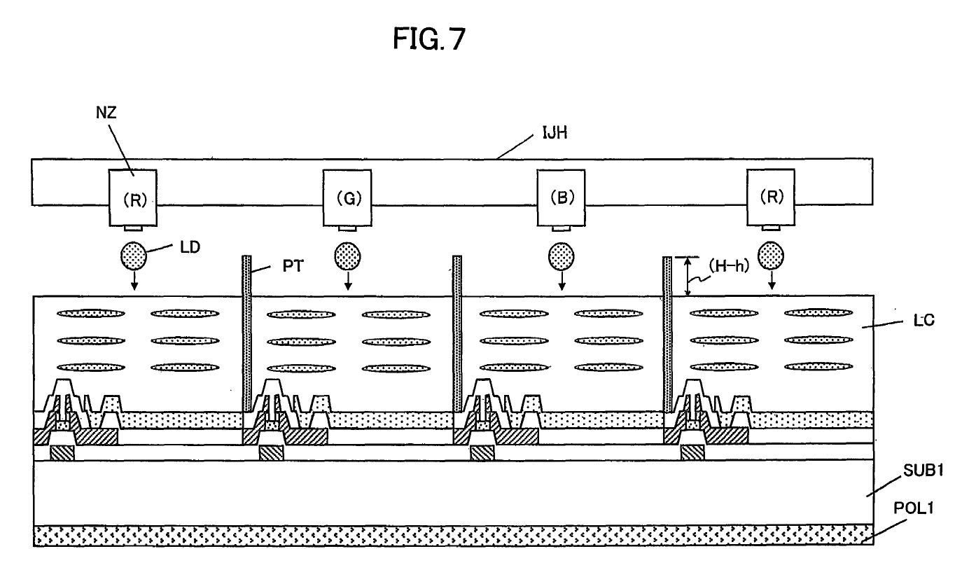

FIG. 7 is a drawing to explain an example of a method for coating the liquid crystal similar to the one shown in FIG. 5, which is to explain the method for manufacturing the liquid crystal display device of the Embodiment 2 of the present invention. In FIG. 6 and FIG. 7, the same component as in FIG. 1 is referred by the same symbol. First, similarly to FIG. 4, a TFT is prepared on inner surface of a glass substrate SUB1, which is a TFT substrate. Then, an orientation film is coated to give liquid crystal orientation control ability. The partition wall PT made of resin is disposed along the data line DT of the TFT substrate. The thickness of the partition wall PT is extremely thinner than its height. The reason is the same as described in the Embodiment 1. The height of the partition wall PT is designed to be higher than the height of the cell gap as explained in connection with FIG. 6. This partition wall PT can be sufficiently prepared by the means such as screen printing method. The partition wall PT may be prepared at a position closer to the CF substrate.

As shown in FIG. 7, the partition wall PT is prepared with a height higher by an amount of (H−h) as compared with the Embodiment 1. After the partition wall PT has been prepared, liquid crystal is dropped to each of individual pixel portions partitioned by the partition wall PT via the ink jet coating head IJH. The coating procedure is the same as in the Embodiment 1.

According to the Embodiment 2 as described above, it is possible to manufacture a liquid crystal display device, which can display a liquid crystal image with high quality and can improve contrast by controlling the changes of chromaticity due to the viewing angle.

### Embodiment 3

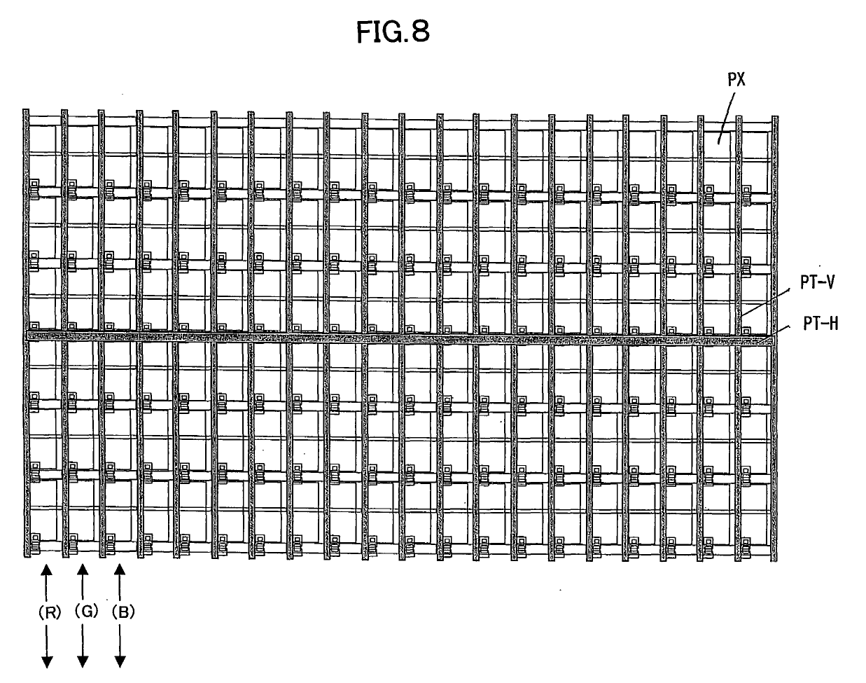

FIG. 8 is a plan view of an essential portion of the device to explain Embodiment 3 of the liquid crystal display device according to the present invention. In the Embodiment 1 and the Embodiment 2, pixels of the same color are arranged in up-to-bottom direction (vertical direction) as shown by bidirectional arrows (see FIG. 3), and partition wall is disposed only between the adjacent pixels in the arranged orientation of the pixels of the same color. In the Embodiment 3, in addition to the partition wall PT-V in vertical direction, a partition wall PT-His also provided in left-to-right direction (horizontal direction). One each of the partition walls PT-His also provided for each of a plurality of pixels in vertical direction. In the present embodiment, one partition wall PT-His disposed per 20 pixels in vertical direction, for instance.

Next, description will be given below on an example of liquid crystal dropping quantity in the Embodiment 3. Here, it is supposed that the size of one sub-pixel is 150 μm×450 μm, and the cell gap is 2.85 μm. Then, the quantity of the liquid crystal to be dropped to a region surrounded by a pair of partition walls PT-V in vertical direction and a pair of partition walls PT-H in horizontal direction to partition 20 pixels is 3847 μl. If it is supposed that the size of the liquid crystal drop is 3.85 μl, the number of liquid crystal drops to be dropped is 1000 drops.

For the purpose of flowing the liquid crystal to fill sufficient liquid crystal quantity for each pixel in an oblong region surrounded by the partition wall PT-V of liquid crystal in vertical direction, it is necessary to drop the liquid crystals in excess quantity. Then, excessive stress is applied to the partition wall PT-H in horizontal direction. According to the present embodiment, in addition to the effects given in the embodiments as described above, the partition wall PT-H in horizontal direction is disposed and the quantity of liquid crystal per each partition is decreased. As a result, the stress can be reduced. Thus, the disadvantage (poor production) caused by the deformation of the partition wall can be prevented.

### Embodiment 4

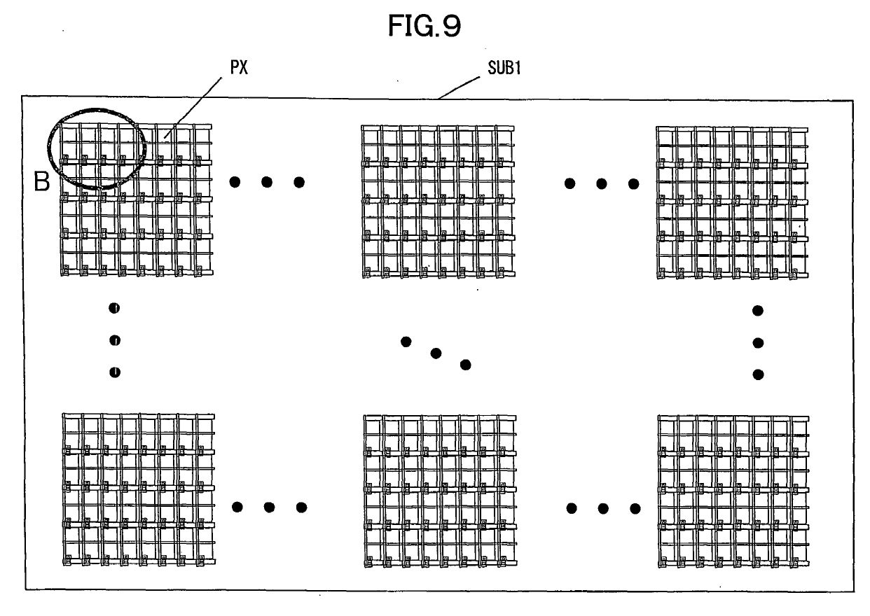

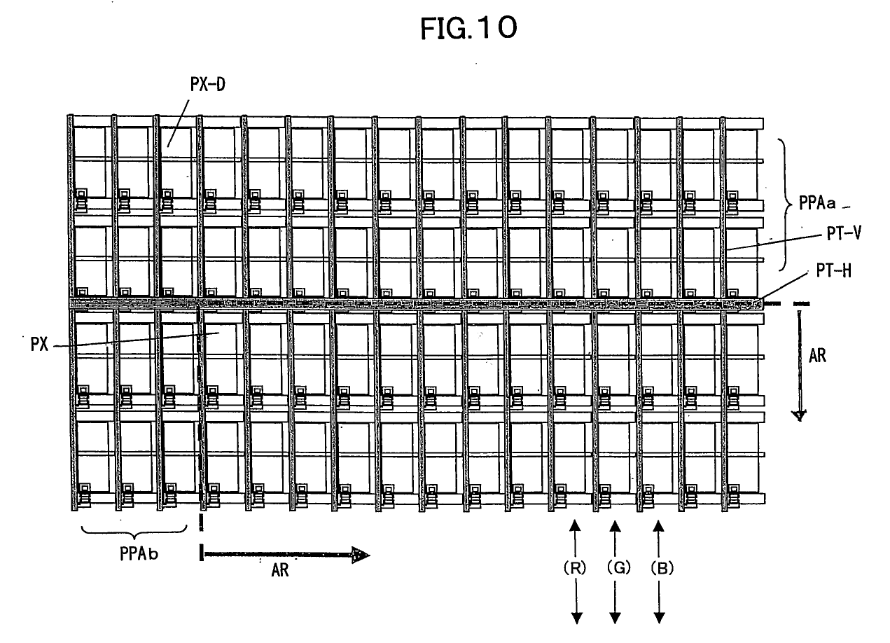

FIG. 9 is a schematical plan view similar to FIG. 2 to explain Embodiment 4 of the liquid crystal display device of the present invention. In FIG. 9, pixels PX in matrix arrangement of 8×4 are shown only at four corners and on upper and lower portions at the center of the glass substrate SUB1. FIG. 10 is a plan view similar to FIG. 8 showing pixels in matrix arrangement of 16×4 shown by enlarging a portion B in FIG. 2. One sub-pixel is prepared on a region surrounded by a gate line GL and a data line DL. In the Embodiment 1, the pixels each in the colors of red, green and blue respectively are arranged in vertical direction as shown by bidirectional arrows in the figure. In other words, color filter columns (R), (G) and (B) of the same color are arranged in the direction of bidirectional arrows.

In the Embodiment 4, one each of dummy pixel PX-D where liquid crystal is not injected is disposed at outer position in vertical direction (i.e. PPAa) and at outer position in horizontal direction (i.e. PPAb) of an effective display area. Specifically, the vertical partition wall PT-V and the horizontal partition wall PT-H as described above are also disposed on boundary portion between PPAa and PPAb, which is a region of the dummy pixel PX-D on the surrounding of the effective display area AR so that the dropped liquid crystal may not leak to outside of the effective display area AR.

In the present embodiment with the dummy pixel areas PPAa and PPAb, when the CF substrates are attached with each other and gap is formed by pressing the two substrates against each other, or when these are packaged in an electronic device, the load to be applied on the partition walls in the effective display area is reduced, and this makes it possible to prevent poor display, which may be caused by leaking of the liquid crystal due to the deformation or defect, etc. of the partition walls at end portions of the effective display area. The other effects are the same as described in the other embodiments.

### Embodiment 5

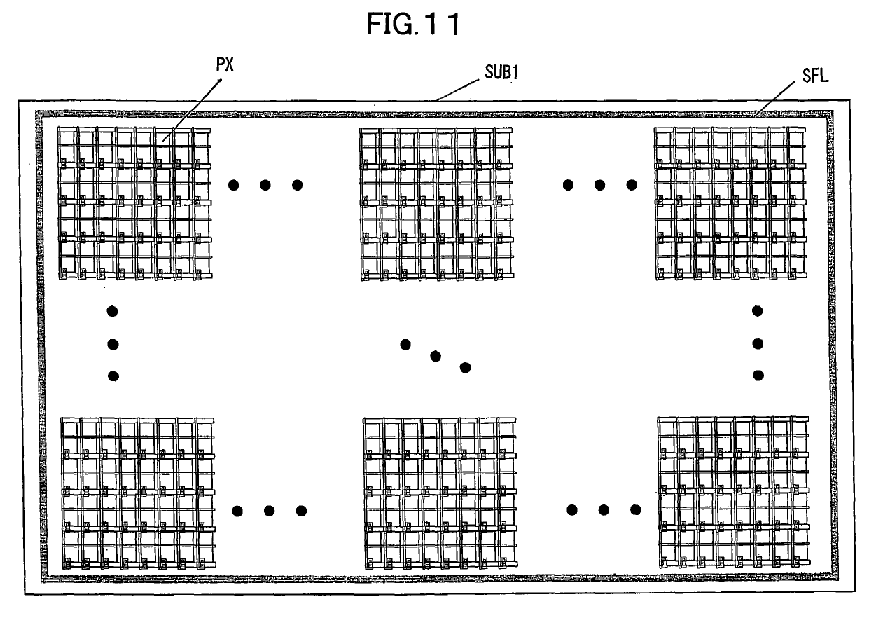

FIG. 11 is a schematical plan view similar to FIG. 9 to explain Embodiment 5 of the liquid crystal display device of the present invention. In FIG. 11 also, the pixels PX in matrix arrangement of 8×4 are shown only at four corners and on upper and lower portions at the center of the glass substrate SUB1. In this embodiment, a resin frame SFL is disposed on outer periphery of the glass substrate SUB1, which is a TFT substrate. The resin frame SFL is made of the same resin material used in the partition wall explained in the embodiments as described above. A sealing material (not shown) is coated on outer side of the resin frame SFL, and a glass substrate SUB2 (see FIG. 1 and others), which is a CF substrate, is attached, and a gap is formed.

According to the present embodiment, when the CF substrates are attached with each other and a gap is created by pressing the substrates against each other, or when it is packaged in an electronic device as a product, a load to be applied on the partition walls in the effective display area can be extensively reduced, and similarly to the Embodiment 4, it is possible to prevent poor display at end portions of the effective display area. The other effects are the same as in the other embodiments as described above. The Embodiment 5 can be combined with the Embodiment 4.

In the above embodiments, description has been given on the present invention by taking an example on a transmission type liquid crystal display device, while the invention can also be applied in a reflection type liquid crystal display device or a semi-transmission and reflection type liquid display device using aluminum, silver, or other metal with high reflectivity. Further, the present invention is not limited to TN-type device as explained in the above but also can be applied to IPS type or VA type liquid crystal display layer.

When the liquid crystal layer is in horizontal orientation, it is desirable that a resin material with vertical orientation is used as the partition wall. When the liquid crystal layer is in vertical orientation, it is desirable that a resin material with horizontal orientation property is used as the partition wall. The reason for this is that orientation disturbance of the liquid crystal can be prevented by the partition wall.

As described above, according to the present invention, the cell gap of the liquid crystal display device is set to a constant value for all pixels, and the value of Δn of the sealed liquid crystal is set to an adequate value for each of the pixels of red (R), green (G), and blue (B). For this purpose, it is arranged that the partition walls are also provided between adjacent pixels with different colors so that each of the liquid crystals can be independent in the pixel of the same color. This partition wall also fulfills the function as a spacer to maintain the cell gap.

Emission spectrum of the pixel extensively varies according to the light source used or to transmission spectrum of color filter. For the central optical wavelength, there are various definitions such as peak wavelength in case of emission spectrum with peak value, or central wavelength of half-band width in case of the spectrum with gentle slope. The decision as to which definition should be used depends on the design matter of each liquid crystal display device. The present invention can provide the effects regardless of whichever definition may be used.

In the present invention, there is no restriction on the types of light source to be used for the liquid crystal display device. For instance, by combining with a light source, which has steep emission spectrum such as LED light source, transmittance (transmissivity) of the liquid crystal layer can be increased, and the better effects can be obtained.

By the liquid crystal display device of the present invention, it is possible to improve contrast by controlling the changes of chromaticity due to the viewing angle, and it can be applied in television set, personal computer monitor or other electronic devices for household use and for industrial use and can give image of superb quality.

1. A liquid crystal display device, comprising a first substrate where a multiple of pixels with different display colors are arranged, a second substrate disposed at a position opposite to said substrate, and a liquid crystal layer sandwiched between said first substrate and said second substrate; and
refractive index anisotropy Δn (λ) of said liquid crystal layer at an arbitrary wavelength λ varies according to display color of said pixel.

2. A liquid crystal display device, comprising a first substrate where a multiple of pixels with different display colors are arranged, a second substrate disposed at a position opposite to said substrate, and a liquid crystal layer sandwiched between said first substrate and said second substrate, and a unit pixel for full color display is constituted by a plurality of sub-pixels with display colors different from each other; and
refractive index anisotropy Δn (λ) of said liquid crystal layer at an arbitrary wavelength λ varies according to display color of said pixel.

3. A liquid crystal display device according to claim 1, wherein, to a first liquid crystal layer applied to a first pixel having one display color with central optical wavelength λ₁ and a second liquid crystal layer applied to a second pixel having the other display color, the following relation can be satisfied:
sin²(π·d·Δn₁(λ₁)/λ₁)>sin²(π·d·Δn₂(λ₁)/λ₁)
where the symbol Δn₁ (λ₁) represents refractive index anisotropy at wavelength λ₁ of the first liquid crystal layer, the symbol Δn₂ (λ₁) represents refractive index anisotropy at wavelength λ₁ of the second liquid crystal layer, and the symbol d represents thickness of the liquid crystal layer.

4. A liquid crystal display device according to claim 2, wherein there are provided partition walls to partition between pixels having different display colors.

5. A liquid crystal display device according to claim 2, wherein a first partition wall for dividing pixels having different display colors is provided, and there is provided a second partition wall to divide one or more pixels having the same display color.

6. A liquid crystal display device according to claim 4 or 5, wherein height of said partition wall is equal to thickness of said liquid crystal layer.

7. A liquid crystal display device according to claim 4 or 5, wherein height of said partition wall is bigger than thickness of said liquid crystal layer.

8. A liquid crystal display device according to claim 4 or 5, wherein said partition wall is made of resin.

9. A method for manufacturing a liquid crystal display device, wherein said method comprising the steps of:
preparing a multiple of pixels, which comprise a plurality of pixels having colors different from each other, on a first substrate;
coating a liquid crystal having different refractive index anisotropy for each different display color on each of the corresponding pixel on said first substrate; and
placing a second substrate at a position opposite to said first substrate, and sealing said liquid crystal.

10. A method for manufacturing a liquid crystal display device according to claim 9, wherein said liquid crystal is coated by ink jet method.
